(19) United States
(12) Patent Application Publication
(10) Pub. No.: US 2008/0243906 A1
(43) Pub. Date: Oct. 2, 2008

(54) ONLINE SYSTEM AND METHOD FOR PROVIDING GEOGRAPHIC PRESENTATIONS OF LOCALITIES THAT ARE PERTINENT TO A TEXT ITEM

(76) Inventor: Keith Peters, San Francisco, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/768,773

(22) Filed: Jun. 26, 2007

Related U.S. Application Data
(60) Provisional application No. 60/909,420, filed on Mar. 31, 2007.

(51) Int. Cl. G06F 17/30

(52) U.S. Cl. 707/102; 707/E17.082

(57) ABSTRACT

Content may be rendered from a network with the inclusion of supplemental geographic information. A text content from a content item is analyzed in order to make a determination as to one or more localities that are identified or relevant to the text. A geographic presentation may be provided with the rendered content using the determination of the one or more localities.

### RELATED APPLICATION

This application claims benefit of priority to Provisional U.S. Patent Application No. 60/909,420, entitled ONLINE SYSTEM AND METHOD FOR PROVIDING GEOGRAPHIC DISPLAYS OF LOCALITIES THAT ARE PERTINENT TO A TEXT ITEM, filed Mar. 31, 2007; the aforementioned priority application being hereby incorporated by reference in its entirety.

### TECHNICAL FIELD

The disclosed embodiments relate generally to the field of an online system for aggregating and displaying information. More particularly, embodiments described herein relate to an online system and method for providing geographic presentations of localities that are pertinent to a text item.

### BRIEF DESCRIPTION OF THE DRAWINGS

FIG. 1 illustrates a method for aggregating text-based content items with locality information, under an embodiment of the invention.

FIG. 2 illustrates a method for searching and displaying text-based content items with locality information, under an embodiment of the invention.

FIG. 3 illustrates a system for enabling aggregation and searching of text-based content items with locality information, under an embodiment of the invention.

FIG. 4 illustrates a data structure for storing text-based content information and locality information, under an embodiment of the invention.

FIG. 5A and FIG. 5B illustrate geographic presentations for use with one or more embodiments described herein.

### DETAILED DESCRIPTION

According to an embodiment, content may be rendered from a network with the inclusion of supplemental geographic information. A text content from a content item is analyzed in order to make a determination as to one or more localities that are identified or relevant to the text. A geographic presentation may be provided with the rendered content using the determination of the one or more localities.

One or more embodiments also provide for a webpage, which may be rendered or maintained as a file for rendering (e.g. on a server, for use by one or more terminals). The web page may include a content that corresponds or is based on a plurality of content items. The web page may further include a geographic presentation that is provided with at least one of the content items. The geographic presentation is generated independently of the given content item and is based on a pertinent locality identified by the given content item.

Embodiments described herein provide a geographic presentation feature that displays relevant localities to an associated content. The relevant localities may be determined through a process of analyzing text data in the content, and determining information that identifies localities of relevance to the content item. Once localities of relevance are determined, embodiments described herein provide various alternatives and implementations by which information contained in a geographic presentation is rendered to the user in association or connection with the underlying content item.

One or more embodiments also provide for webpage (or web presentation) provided from a server to any one or more of a plurality of terminals that communicate with the server. The webpage may include a content that corresponds or is based on a plurality of content item. A geographic presentation is provided with at least a given one of the plurality of content items. The geographic presentation may be generated independently of the given content item and is based on a pertinent locality identified by the given content item.

In one embodiment, the geographic presentation is generated independent, in that it is not created as part of the content item. For example, the source of the content item's location (when external) may perform no processes to create the geographic presentation, and/or to locate the pertinent locality of the geographic presentation. Rather, the content item may be retrieved from a site that is configured under an embodiment described herein, so to be enabled to determine the pertinent locality and to generate the graphic presentation. As an addition or alternative, the generation of the graphic presentation may also be considered independent in that the graphic presentation and pertinent locality determination are made from the content of the content item, rather than as part of the content item.

Embodiments described herein provide a mechanism by which location-based display items can be generated in various environments that utilize documents and other data item to aggregate words and search terms from various network sources.

Additionally, an embodiment enables the location-based display item to be generated in association with a text item that occurs in any one of a plurality of source documents.

One or more embodiments described herein may be implemented through the use of modules or software/logic components. A module refers to a program, a subroutine, a portion of a program, a software component, firmware or a hardware component capable of performing a stated task or function. A module can exist on a hardware component such as a server independently of other modules, or a module can exist with other modules on the same server or client terminal, or within the same program. A module may be implemented on a client or on a server, or distributed between clients, servers, or amongst a client-server.

Furthermore, one or more embodiments described herein may be implemented through the use of instructions that are executable by one or more processors. These instructions may be carried on a computer-readable medium. Services and components illustrated by figures in this application provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage components, such as CD or DVD components, flash memory (such as carried on many cell phones and PDAs), and magnetic memory. A computer-readable medium as used herein may extend across multiple machines. For example, the medium may be distributed between client and server in order to perform a stated task or operation.

Methodology

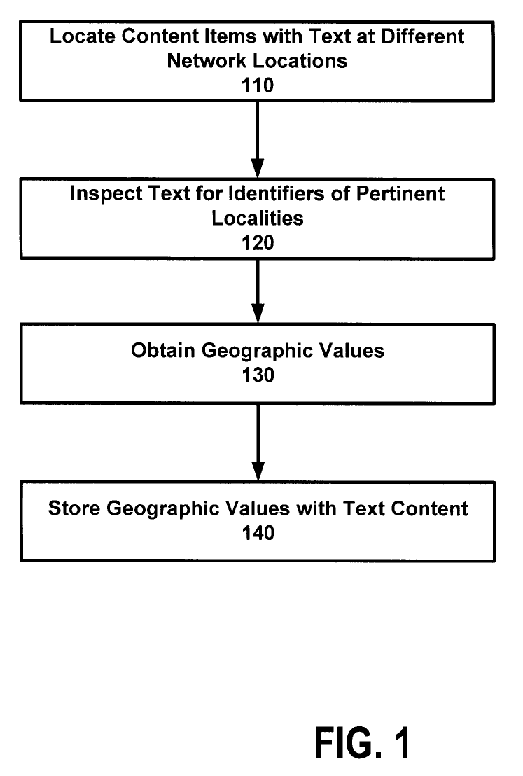

FIG. 1 illustrates a method for aggregating and subsequently using data that includes locality-based information, under one or more embodiments of the invention. A method such as described may be implemented by a process that crawls or seeks to programmatically procure text content from different network locations, such as provided by different websites. Accordingly, in a step 110, a text-based content item is located. The text-based content item may include content provided over the World Wide Web (“WWW”), such as in the form of a web page. Examples of the content item include news articles, stories, web logs (“blogs”), and/or online message boards (“forums”).

At step 120, retrieved content items are individually inspected or analyzed for information that is indicative of a pertinent locality. The pertinent locality refers to a location that, for example, is pertinent to an event of the story. For example, in a news story, localities of interest may correspond to the address, intersection or neighborhood where a specific news event occurred (e.g. crime location or public event.) In one embodiment, a library of keywords, references, and/or proper names may be used to identify instances when one or more localities are pertinent to the text of the content item. The text of the content item may be scanned for key phrases that may be associated with specific localities. For example, the text of a content item may include proper names, geographic locations, and/or other identifiers, including very generically, the names of a state, province, city, and/or a specific street address in reference to its content. In addition, the identifiable phrase may include, for example, a landmark (e.g. “Great America”, “LAX”, “Moffett Field”) or a nickname for a specific locality (e.g. “The Rock”, “The Farm”, “The Strip”). Although the primary focus of the content item may pertain to one specific locality, one or more different localities may also be referenced in the text. For example, a news article detailing political rallies in different cities across the country may list specific city blocks, intersections and neighborhoods in the different cities.

In another embodiment, the information contained in the scanned content item may provide a hint at a locality of relevance or pertinence to the content item, without actually identifying the locality with words or names. For example, the content item may make indirect reference to a particular locality. One or more embodiments contemplate use of programmatic intelligence or inferences that can be used to identify a specific locality. As an example, the phrase “Governor is meeting with lawmakers before heading overseas” may be inferred to identify the “state capitol” as the pertinent locality through use of inferences. Programming or logic may inference the “state capitol” when the “Governor” appears in a news story, and further confirm the locality with use of the words “lawmakers”.

At step 130, information (e.g. keywords or proper names) that is indicative of a locality in the text content (as determined from step 120) is cross-referenced to a library or reference resource in order to obtain a geographical value (GV). In an embodiment, cross-referencing may be performed by employing a third-party mapping service to generate the geographical value. In one implementation, the mapping service may be available on a network or over the Internet at a website. Examples include mapping services provided by GOOGLE INC. The network site(s) of one or more mapping services may be queried with an identification of a locality, and the response to those queries may be used to store the geographical value. The geographical value may include a pair of latitude and longitude coordinates which specify the exact geographical location. Alternatively, a network identifier or link (e.g. URL) to the location where a map of other information about the particular locality is generated may be stored as the geographical value.

According to one or more embodiments, step 130 may be performed in conjunction with a formatting step to prepare data for query in a mapping engine. Information identifying the locality may first be referenced or manipulated to fit a form that is acceptable by the mapping service. For example, if the determined information is an intersection, step 130 may require construction of a query that presents the identification of the intersection, including the streets, city and state, in a format and sequence that is acceptable to the mapping service. For example, the query may be sequence the information in accordance with rules of how the mapping engine receives input manually.

As an example, an output of step 120 may correspond to identification of (i) city and state, and (ii) intersection or street address within that city and state. The identifications may be made through key word identification, or other phrases or words that are indicative of a particular locality. From this identification in step 120, step 130 may result in a determination of a longitude and latitude with the identified locality.

The geographical value is then stored, at step 140, in association with the content item from which the geographical value was generated. As mentioned, the geographical value may correspond to a set of latitude and longitude coordinates, to a link or URL for a specific set of coordinates, and/or other map-service friendly identification information. One or more embodiments contemplate content items for which multiple geographical values are determined and then stored in association, as the case where multiple localities are pertinent to a news item. A method such as described with an embodiment of FIG. 1 may be repeated for numerous network sites and content items contained therein.

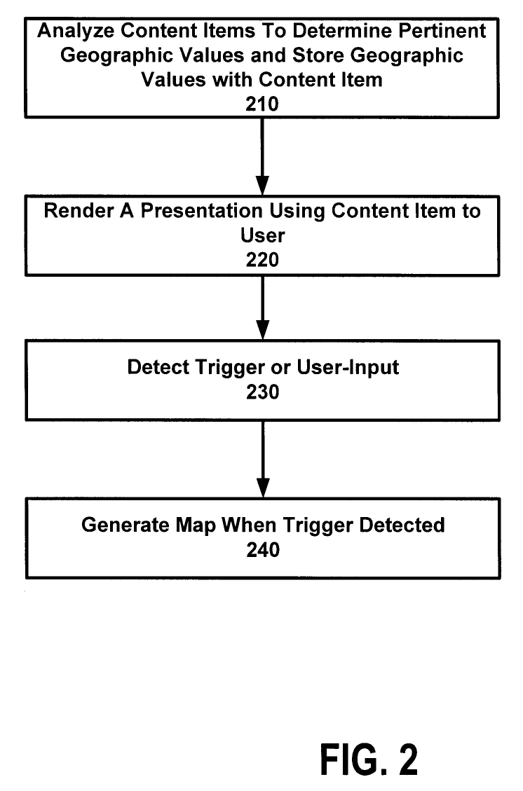

FIG. 2 illustrates a method for displaying or rendering content items in association with a geographical presentation, which may include maps, locality information, and/or other graphic displays corresponding to the localities. For example, the graphic display may be in the form of a satellite image of one of the localities of interest, or alternatively, the graphic display may be in the form of a hybrid combination of a map and a satellite image. In a step 210, content items are analyzed to determine geographical values, and to store those geographical values in association with the content items. The maps/geographic displays may be rendered as part of a presentation that displays a locality of relevance in the content item. The identification of the locality of interest, along with the aggregation of information, may be performed under a process or method such as described with an embodiment of FIG. 1. One or more embodiments may utilize relational data, such as in the form of a database, to make the association between geographical values and the content items.

At step 220, a web page or other presentation is rendered to a user that links to or includes some or all of the content of the content item. The rendering may be made in response to some user action or set of actions that is communicated to the website. For example, the website may correspond to a portal or information aggregation site, and the user's action may correspond to the user navigating and selecting specific links on the site. As an alternative or addition, the user may perform a search using keywords, for documents and other content provided or hosted from the web site.

According to an embodiment, step 230 detects a user input or other activity or event that triggers the rendering of a map or other visual geographic information. In one embodiment, for example, the triggering event may correspond to the user opening, or selecting to open, a document or story that includes geographical values associated with it. In another implementation, the trigger event may correspond to the user viewing a summary page on which numerous articles or links are displayed. Some or all of the links may cause the user's browser to open a document from a location that is outside of the domain of the site. The trigger event may correspond to programming that runs on the website (e.g. Javascript) or on a terminal. The programming may detect the user viewing a link or other summary of a content item for which the geographic information is associated. Still further, documents (when opened or rendered) or summaries or links to documents may be presented with icons or other graphic user-interface features that are selectable to cause the rendering of a map or other graphic corresponding to the locality of interest.

In a step 240, a map or other geographical display is generated in response to the triggering event of step 230. In one implementation, the geographical values (e.g. latitude and longitude coordinates) may be supplied to a mapping service, such as hosted on the Internet by a third-party, in order to generate a map of a locality identified by the geographical values. As an addition or alternative, the geographical display may include a map and/or information about: historical facts, landmarks, businesses, restaurants, and/or hotels. Another resource, for example a local directory (e.g. Yellow Pages), may be referenced for additional information on the location. Thus, for example, one or more embodiments may display a map of a locality of interest, along with identification (either on the map or separately listed) of a business (or landmark etc.) that is of interest to the content item identified with the with the address.

Numerous implementations and embodiments are contemplated for how maps and other graphics corresponding to the relevant localities are presented to the user in connection with content derived or corresponding to a particular content item. In an embodiment, the geographical presentation may be selectively presented beside a rendered or partially rendered content item, so as to be a fixed item on a web page of the rendering. Alternatively, the geographical presentation may be presented in dynamic form, such as a floating object on the web page. In alternative embodiments, the geographical presentation may be hidden and displayable in response to user action (such as described in step 230), including selection or hovering by a pointer feature. The geographic presentation may be combined or hidden with an object, such as an image, an icon, a link, and/or a text word. In another embodiment, the geographical presentation may be presented as a “pop-up” window, or on a separate web page.

System Description

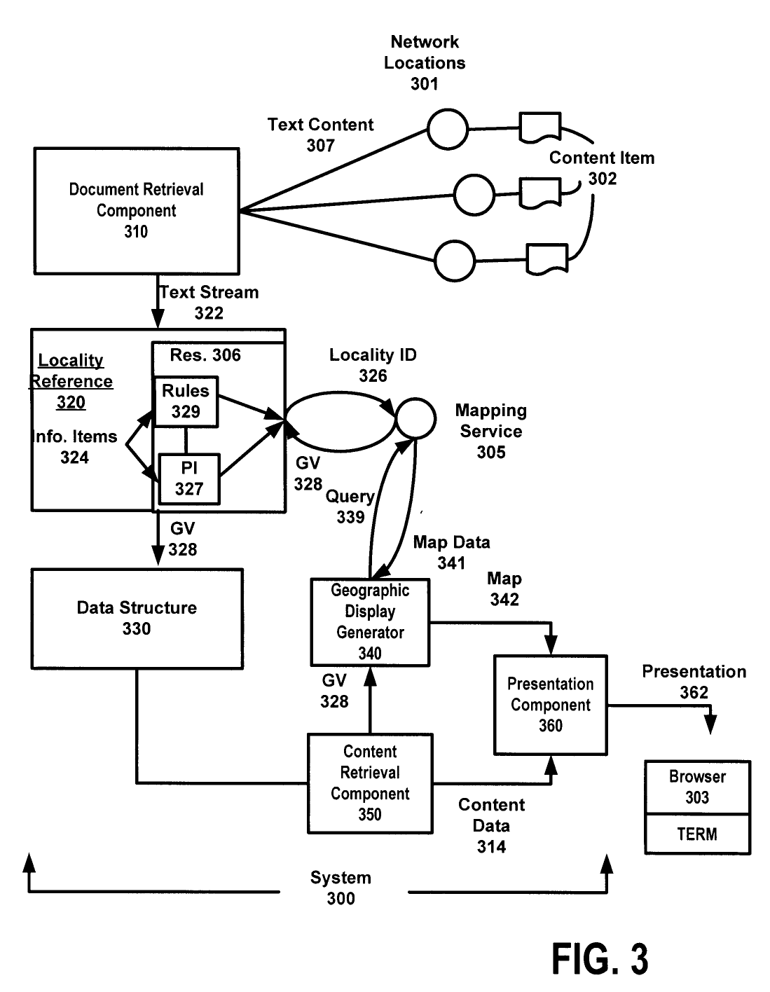

FIG. 3 illustrates a system for enabling aggregation and searching of text-based content items with locality information, under an embodiment of the invention. According to one or more embodiments, a system such as described with an embodiment of FIG. 3 may be used to perform one or more embodiments such as described with FIG. 1 and FIG. 2.

In an embodiment, a system 300 includes a document retrieval component 310, a locality reference component 320, a data structure 330, a geographical display generator 340, a content retrieval component 350, and a user interface 360. The system 300 may be accessed and used by a user operating a terminal on which a browser 303 is executed. The user may operate a terminal and connect to the system 300 via a network connection (such as Internet connection).

Backend

According to an embodiment, the document retrieval component 310 executes programmatically and/or automatically to retrieve content items from a plurality of network locations 301. The plurality of network locations may be operated on multiple domains. Examples of network locations include those provided with various web sites on which text content 302 is provided. Such locations may host or provide content items in the form of, for example, news stories, blog entries or other content items. Content items 302 may be identified and retrieved from files and other content items (e.g. portions of documents) that are provided at the different network locations. For example, the document retrieval component 310 may parse content items 302, in the form of web pages or other files, in order to identify text content 307 from which subsequent analysis is performed. The document retrieval component 310 may also identify and store information (e.g. URLs) for locating the network location of the content items 302.

In an embodiment, a locality reference component 320 receives a text stream 322 from document retrieval component 310. The document retrieval component 310 may output text stream 322 parsed from each of the retrieved content items onto the text stream. In one embodiment, locality reference component 320 scans or otherwise inspects the text stream 322 (or portions thereof) in order to identify one or more information items 324 that are indicative of localities that are pertinent to the text content of the content item 302. The information items 324 may be in the form of key words, names, character strings or phrases.

In an embodiment, the information items 324 may correlate to identifiers of localities (“locality identifier 326”). The locality identifier 326 may correspond to a proper name, address, or geographical value that locates a region or specific location. As an alternative to making a direct correlation to the locality identifier 326, the information items 324 may provide inferences, such as by way of hints or clues, as to a particular locality identifier 326 that is pertinent to a particular content item 302. For example, the clues or hints may provide an indirect correlation to the locality identifier 326. For example, the information item 324 may correspond to a phrase provided in the text of a content item 302: “they call the bend ‘Death's Corridor’”. This information item 324 may be used in connection with the known state or even city or county mentioned in the content item 302 to reference a particular mile marker on a bend in highway. The particular mile marker may be known for the scene of accidents. Another example may correlate the nickname of a neighborhood or famous event (e.g. the site of the “Riot”) to a specific locality. A library of resources 306 (or individual resources thereof), such as in the form of directories, programmatic intelligence, rules, and lists, may be used to correlate information items 324 to identification of specific localities, either by name, geographic value, or otherwise. For example, the library of resources 306 may enable a programmatic correlation to be drawn between the appearance (in text) of the phrase “Death's Corridor” to a longitude and latitude, or alternatively to a street address. As additional examples, the information items 324 may identify or infer a state, a province, a city, a street address, a landmark, a building, a segment of a roadway, a park, a museum or a nickname for any of the aforementioned.

According to one or more embodiments, the locality reference component 320 uses one or more resources 306 to assist in the identification of the one or more localities. The information items 324 may initially be identified as candidates for locality identifiers, meaning that not every information item 324 may correlate or be used to determine the locality identifier 326. To the contrary, only a few words or phrases may correlate to locality identifiers for a given content item (e.g. news story). In one embodiment, the text of content item 302 is scanned and proper names and nouns are identified as information items 324. Other words in the text may be referenced against one of the resources 306. Certain information known about the geographic relevance of the content item 302 may be used to narrow or focus the reference against the resources 306.

In an embodiment, the library of resources 306 (used by the locality reference component 320) includes one or more directories 307 and programmatic intelligence 327. In an embodiment, the programmatic intelligence implements a set of rules 329 on correlating specific types of information items 324 (e.g. to locality identifiers). For example, the programmatic intelligence 327 may correlate the appearance of “San” with a locality when capitalized. The rules may also provide for locations in the text of the content item where information items 324 are more likely to be locality identifiers. For example, news articles often include a city or other location as the first word or words of the text. From this, the locality reference component 320 may narrow than the field of comparison, and reference words in the text to known sites, addresses, landmarks etc, in the particular city or identified geographic region. Still further, the rules or other elements of programmatic intelligence 327 may weigh certain conditions in determining whether a given information item 324 is a locality identifier. For example, a capitalized word following a comma may be deemed more likely to be a locality identifier. In one embodiment, some or all candidate information items 324 may be references against various lists, directories or indexes to confirm or determine that the particular information item 324 is a locality identifier.

In addition to examples in which nicknames may be referenced to defined geographic locations, directory 306 may correspond to a service (e.g. electronic Yellow Pages) or library that cross-references names of businesses with street addresses. One or more embodiments provide that the determination of the locality identifier is supplemented with names of businesses or other geographic information that may be of interest to the viewer of the rendered content.

Still further, the locality reference component 320 may use algorithmic or determinative logic as past of the programmatic intelligence 327 when identifying pertinent localities of a content item 302. For example, the content item 302 that references the death of a movie star may make no mentioned of where the movie star died. But program intelligence may reference the name of the deceased star to a business or address where the individual died.

For content items 302 that user-generated, such as comments to news stories and blogs, a pertinent locality may correspond to the location of the user. In such cases, information provided from the user may be used as, or used to obtain the locality identifier 326. For example, the user may identify his location when making a post. Alternatively, he may submit a post from a location that can determined from his IP address during his network location. For example, the poster may use a computer at a University, as determined from his IP address. In this case, the address of the University may serve as the locality identifier 326.

After an individual content item is analyzed, the locality reference component 320 may subsequently generate a set (of one or more) geographical values 328 based on one or more of the locality identifiers 326 determined from the individual content item. In one embodiment, the locality reference component 320 sends information corresponding to the locality identifier 326 to mapping service 305. The mapping service 305 may reside external to the system. For example, mapping service 305 may correspond to a mapping engine, programmatically accessible over the Internet. In order to determine the geographical values 328, the information corresponding to the locality identifier 326 may be formatted for the mapping service. Specifically, the information may be provided with formatting considerations, such as an order or sequencing of words (e.g. street number, street, city and zip code) so as to be recognizable input by the mapping service 305. According to one embodiment, the locality identifier 326 may be formatted as an address, provided in a particular format, with information that may not be directly obtainable from the content item 302 (e.g. the state where the locality resides). A formatting component (not shown) may be integrated with the locality reference component 320 in order to format the information provided to the mapping service.

The service 305 may cross-reference the locality identifier 326 in order to determine a geographical value 328 for that locality identifier. In one embodiment, the geographical values 328 correspond to a set of latitude and longitude coordinates for the locality identifier 326. The locality reference component 320 may then output the geographical values 328 to be stored in a data structure 330.

In conjunction with locality reference component determining geographical values 328, the document retrieval component 310 may store in the data structure 330, for individual content item 302, one or more of (i) the content item 302 (as copied), (ii) a location or link to the content item, and/or (iii) content derived or otherwise based on the content item 302 (e.g. summary content. Data stored by the document retrieval component 310 may collectively be referenced as “content data 314”). The content data 314 may be stored, in the data structure 330, in association with one or more geographical values 328 output from the locality reference component 320. As such, the geographical values 328 determined for a particular content item 302 may be maintained in association with that content item when stored in the data structure 330.

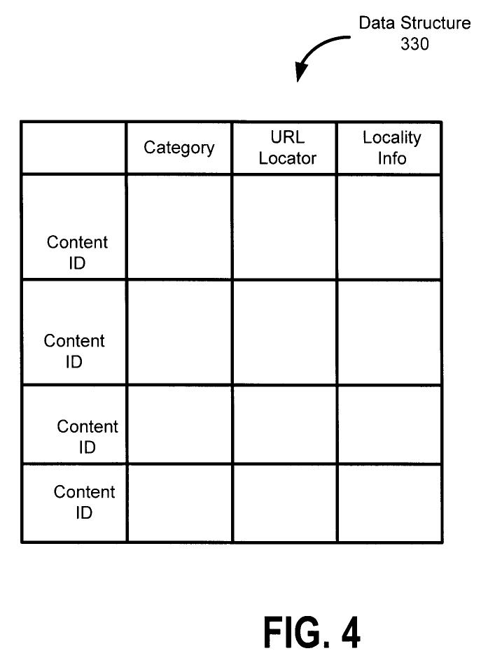

FIG. 4 illustrates a data structure 330, structured for storing text-based content information and geographical values, under an embodiment of the invention. As illustrated in FIG. 4, the data stored may include a content identifier associated with attributes that include a category 402, a URL or other location identifier 404, and one or more sets of geographical values 406 are other locality information. Alternatively, images of maps or other locality information may also be stored in the data structure/

Front End

The front end of a system such as shown by FIG. 3 enables a user to operate the browser 303 to navigate, search and perform other browsing activities to view pages and other network resources provided by the system. According to one implementation, a system of FIG. 3 provides an online source of aggregated content, procured from a variety of network locations. The user may access the site, and navigate, search and browse aggregated content. Web pages may be rendered to the user that present the summaries or aggregations (e.g. by category) of the content items.

In one end, the front end of the system includes the content retrieval component 350 and the geographic display generator 340. In one embodiment, the user may select to view content data 314, corresponding to, for example, content summary and/or link to a particular content item 302. The content data 314, or the page rendered with content data 314, may be displayed with a map 342 (or other graphic display or information) if geographical values 328 are associated with that content item 314 (as provided from the backend). The presentation component 360 generates a presentation 362 comprising content data 314 specified by the user. If the content data 314 used in the presentation 362 includes geographical values, a graphic feature (e.g. icon) may be displayed with the presentation 362. The user may select the feature in order to trigger the geographic display generator 340 to provide a map 342 for the presentation 362. The geographic display generator 340 may send a query 339 to the mapping service 305 (the same or a different mapping service may be used as compared to the service for procuring geographical values) that specifies the geographical values 328 in order to receive mapping data 241 and generate or otherwise display the map 342 to the user-terminal. Alternatively, the geographic display generator 340 may simply receive geographical values 328 from (or acting as part of) the content retrieval component 350 and generate the map 342 by querying the mapping service 305. The presentation 362 may be in the form of a web page, and the content data 314 and map 342 may be provided as the primary component of the web page, or a portion thereon.

In one embodiment, the presentation component 360 is responsive to user browsing activities. The presentation component 360 may detect a trigger action (e.g. user elects to view content data 314 for an item that has associated geographical values). In response, the geographical display generator 340 retrieves the geographical value 328 from the data structure 330. The geographical value 328 may be submitted to the same or different mapping service 305, which then outputs the map 342. As an addition or alternative, the geographical display generator 340 may utilize another resource, for example a local directory (e.g. Yellow Pages), to generate additional information pertaining to the identified localities.

With regard to an embodiment of FIG. 3, various embodiments described therein may be implemented using components that connect or communicate across the WWW and Internet, and/or other networks. For example, the content items 302 may be located at network locations 301 that are on a separate domain from system 300. Furthermore, the mapping service 305 may be operated from a given network site. The user-terminal may communicate with system 300 using any one of many networks, including cellular networks (e.g. the terminal may correspond to a mobile computing device that is a cell phone).

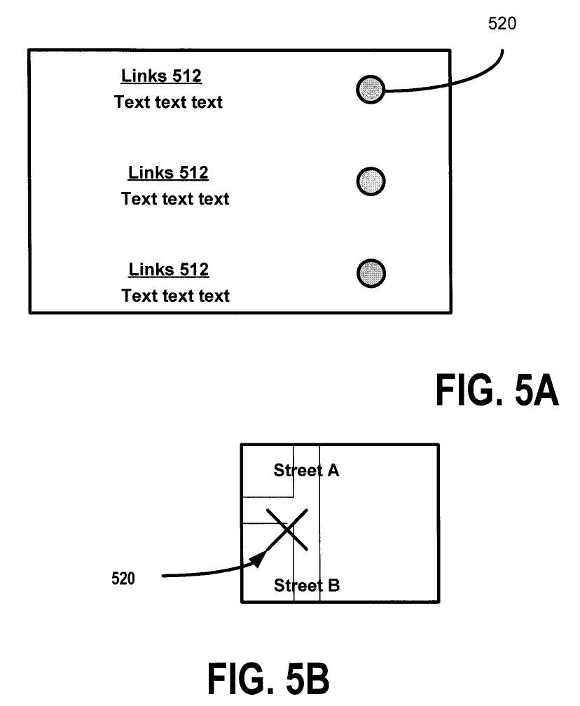

The geographical display may then be combined with the content data 314 of the content item as part of a web page or other presentation 362 to the user. FIG. 5A and FIG. 5B illustrate one context for which a map or other graphic display may be rendered with a web page or other presentation. In FIG. 5A, the web page 510 displays links 512 to other content items. Each of the links 512 are selectable to cause the user's browser to navigate to the network location of the content item. An icon 520 may be displayed or associated with one or more of the links 512. The icon 520 is selectable to cause as geographic presentation to be rendered for the user in connection with one or more of the links. In an embodiment such shown, the geographic presentation previews for the user information about the content provided by the link. Specifically, the geographic presentation may visually indicate the locality of relevance for the content provided by one or more of the links 512. Thus, the user may select which links are of interest by viewing the geographic presentation provided with individual links 512.

FIG. 5B illustrates a geographic presentation 530, as provided by one or more embodiments of the invention. In one implementation, the geographic presentation 530 may include an animated map, or alternatively a satellite imagery map, or still further a hybrid combination of an animated and satellite imagery map.

Other embodiments contemplate that the geographic presentation 530 is open adjacent to associated links 512, rather than selectable to be opened. Still further, one or more embodiments provide that the geographic presentation may combine geographical values of content from different links. For example, one map may show a relevant locality for two content items.

Still further, the geographic presentation 530 may be provided when a content item is rendered. The geographic presentation 530 may be rendered in the same window, separate pop-up window, or as static or dynamic media that overlays other content of the content item or web page. Numerous other variations or combinations are also contemplated.

While embodiments such as described by FIG. 3 provide for a network environment, other variations are contemplated in which the network environment may be omitted entirely or in part. For example, the document retrieval component 310, or its equivalent, may operate on a local data source, such as a personal computer. Data structure 330 may include entries from documents that are both local or on the network sites, or alternatively just local. Furthermore, while an embodiment such as described with FIG. 3 describes the user interface 360 as being a web page that is downloaded on the browser 303, the particular location of the user interface 360 or the data structure 330 may vary between client and server. In a stand-alone variation, the user interface 360 corresponds to an application that executes on the browser 303 and operates on data structure storing local documents and content. Numerous other variations are also contemplated.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for rendering content over a network, the method comprising:
analyzing a text content from a content item in making a determination as to one or more localities that are identified or relevant to the text; and
generating a geographic presentation using the determination of the one or more localities.

2. The method of claim 1, wherein generating a geographic presentation using the determination of the one or more localities includes providing the geographic presentation on a web page in proximity or adjacent to a summary, link or rendering of the content item. text-based content item.

3. The method of claim 1, wherein generating a geographic presentation using the determination of the one or more localities as dynamic content in connection with a rendering of at least a portion of the content item.

4. The method of claim 1, wherein making a determination as to one or more localities that are identified or relevant to the text includes identifying at least one of: (i) a street address, (ii) a landmark, (iii) a neighborhood, (iv) a nickname of a neighborhood or region, (v) an intersection, (vi) a place of business, or (vii) a government building.

5. The method of claim 1, wherein generating a geographic presentation includes displaying a graphic corresponding to one or more of (i) a map of the one or more localities, (ii) a satellite image of the one or more localities, or (iii) a hybrid map and satellite image of the one or more localities.

6. The method of claim 5, wherein generating a geographic presentation includes displaying information in connection with the graphic.

7. The method of claim 6, wherein displaying information includes displaying information corresponding to one or more of (i) historical facts, (ii) relevant landmarks, or (iii) a name of a business that is in the identified locality.

8. The method of claim 1, wherein generating a geographic presentation includes referencing the identified one or more localities to a resource for a geographical value.

9. The method of claim 8, wherein referencing the identified one or more localities to one or more resources includes querying a mapping service over a network to determine the geographical value.

10. The method of claim 9, wherein querying a mapping service includes formatting or structuring a query for the mapping service based on information that is determined from or corresponds to the one or more localities.

11. The method of claim 10, wherein querying a mapping service includes determining a locality identifier that is in a form that is acceptable to the mapping service, and using the information item in querying the mapping service.

12. The method of claim 11, wherein analyzing a text content from a content item in making a determination as to one or more localities includes identifying one or more information items that are candidates for locality identifiers from the text content, and determining the locality identifier for querying the mapping service by referencing the one or more information items to another resource.

13. The method of claim 12, wherein the other resource corresponds to a list or directory that identifies a name as being one or more of (i) a business, (ii) a nickname of a geographic region, or (iii) a landmark.

14. The method of claim 12, wherein the locality identifier for querying the mapping service corresponds to a street address.

15. The method of claim 8, wherein the geographical value corresponds to a value for latitude and longitude.

16. The method of claim 1, further comprising detecting a user input on a web page on which the geographical presentation is provided, and providing the geographical presentation in response to the user input.

17. The method of claim 16, wherein detecting the user input includes detecting the user selecting a link to the content item that is associated with the geographical value.

18. A system comprising:
a document retrieval component that is configured to retrieve a plurality of content items from a plurality of network sites, including a given content item from a corresponding network location, wherein the document retrieval component parses the given content item to output a text stream;
a locality reference component is coupled to the document retrieval component in order to use the text stream to determine a pertinent locality corresponding to the given content item; and
a geographic display generator that is configured to generate a geographic presentation for the given content item, wherein the geographic presentation is based at least in part on the pertinent locality.

19. The system of claim 18, wherein the locality reference component is configured to inspect the text stream for one or more information items that corresponds to at least one of: (i) a key word, (ii) a name, (iii) a character string, or (iv) a phrase; and wherein the locality reference component uses the one or more information items in determining the pertinent locality.

20. The system of claim 19, wherein a given one of the one or more information items provides an inference to the pertinent locality.

21. The system of claim 18, wherein the locality reference component is configured to inspect the text stream for one or more information items that corresponds to the pertinent locality, and wherein the locality reference component references a resource directory to associate the information item to the pertinent locality.

22. The system of claim 18, wherein the locality reference component communicates with a mapping service to perform at least one of (i) generate a geographical value based on the pertinent locality, and (ii) generate the geographic presentation using the geographical value of the pertinent locality.

23. The system of claim 18, wherein the geographic presentation corresponds to one of (i) a map of the one or more localities, (ii) a satellite image of the one or more localities, or (iii) a hybrid map and satellite image of the one or more localities

24. The system of claim 22, further comprising:
a data structure that includes data corresponding to the geographical value provided from the locality reference component communicating with the mapping service, and to store, in association with the geographical value, a content corresponding to at least one of: (i) the content item, (ii) a link to the content item, and (iii) content derived from the content item;
a presentation component that displays the content as part of a presentation that includes the geographic presentation for the content item corresponding to the content.

25. The system of claim 24, wherein the geographic display generator is configured to access the geographical value from the data structure, and to utilize the mapping service to generate a map or geographic image that is based on or selected using the geographical value.

26. The system of claim 25, wherein the geographic display generator utilizes a local directory to generate additional information associated with the pertinent locality.

27. The system of claim 25, wherein the presentation generated by the presentation component further comprises the map output by the geographic display generator.

28. A webpage provided from a server to any one or more of a plurality of terminals that communicate with the server, comprising:
a content that corresponds or is based on a plurality of content items; and
a geographic presentation that is provided with at least a given one of the plurality of content items, wherein the geographic presentation is generated independently of the given content item and is based on a pertinent locality identified by the given content item.

29. The webpage of claim 28, wherein the geographic presentation is dynamically formed on the webpage.

30. The webpage of claim 28, wherein the geographic presentation is selectively presented with the given content item.

31. The webpage of claim 30, wherein the geographic presentation corresponds to a satellite image of the pertinent locality.

32. The webpage of claim 31, wherein the geographic presentation corresponds to a map, or a hybrid satellite image and map of the pertinent locality.
